(19) United States
(12) Patent Application Publication
(10) Pub. No.: US 2010/0212763 A1
(43) Pub. Date: Aug. 26, 2010

(54) Well gauging system and method

(76) Inventor: Stephen R. Means, Bakersfield, CA (US)

Correspondence Address: LITMAN LAW OFFICES, LTD., POST OFFICE BOX 41200, SOUTH STATION, ARLINGTON, VA, 22204, US

(21) Appl. No.: 12/591,224

(22) Filed: Nov. 12, 2009

Related U.S. Application Data
(60) Provisional application No. 61/202,389, filed on Feb. 24, 2009.

(51) Int. Cl. F16K 11/00

(52) U.S. Cl. 137/861; 137/1

(57) ABSTRACT

The well gauging system and method includes two containment vessels, a common inlet line to the vessels with divert control valves on each inlet line of the vessels being controlled by a programmable logic controller (PLC), a common outlet line to the vessels, a common gas line attached to the top of each vessel, which has low and high pressure regulators allowing control of the vessel's internal pressure, a vertical level indication device for controlling level in each vessel, a water cut meter used to report water cut of the production stream, a coriolis meter, valves, gas cylinder, a controller for process control of well testing, storing results, and sending results to a customer's central computer. The method of using two vessels allows more time for the emulsion to separate, thus increasing the accuracy of the oil, water, and gas measurements.

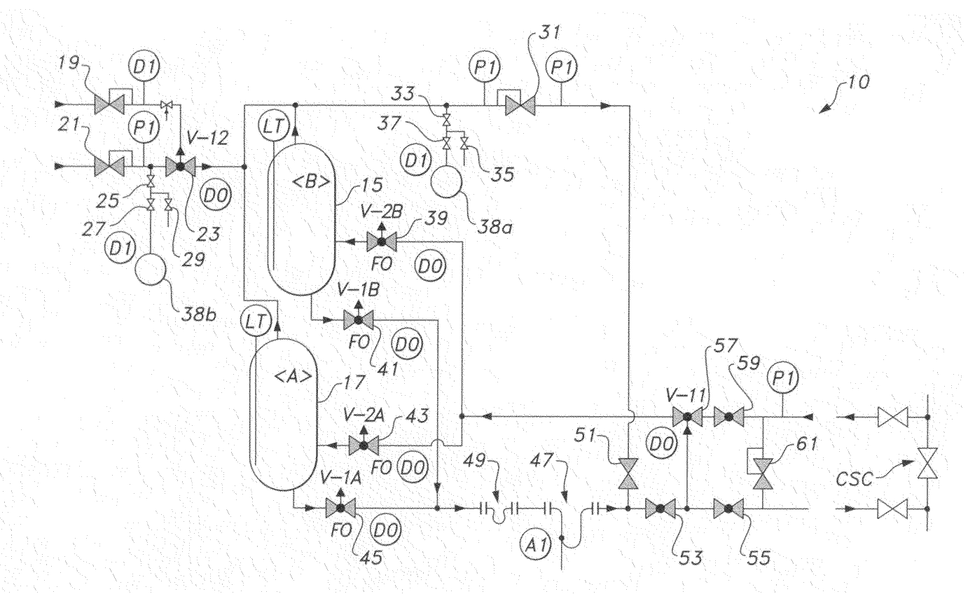

### CROSS-REFERENCE TO RELATED APPLICATION

This application claims the benefit of U.S. Provisional Patent Application Ser. No. 61/202,389, filed Feb. 24, 2009.

### BACKGROUND OF THE INVENTION

1. Field of the Invention

The present invention relates generally to automatic well test systems. More specifically, the invention is a well gauging system and method for testing production wells, including measuring and determining the amount of oil produced per day, water produced per day, and gas produced per day on a well.

2. Description of the Related Art

In the oil and gas production industry it would be desirable to have an automatic well test system that could operate in an efficient and accurate manner while testing production wells for amount of oil produced per day, water produced per day, and gas produced per day. A particular problem with respect to efficient and accurate measurement of the aforementioned production amounts is that many test systems do not allow for a sufficient emulsion separation time.

Thus, a well gauging system and method solving the aforementioned problems is desired.

### SUMMARY OF THE INVENTION

The well gauging system includes two containment vessels, a common inlet line to the vessels with divert valves on each inlet line of the vessels which may be opened or closed by a programmable logic controller (PLC), a common outlet line to the vessels, a common gas line attached to the top of each vessel which has low and high pressure regulators allowing control of the vessel's internal pressure, a vertical level indication device for controlling level in each vessel, a water cut meter used to report water cut of the production stream, a coriolis meter, valves, gas cylinder, a PLC or FieldVision™ NOS to control the process of well testing, store results, and send results to a customer's central computer. The system is mobile or fixed and can operate using solar power, site power, or generator power. The method of using two vessels allows more time for the emulsion to separate, thus increasing the accuracy of the oil, water, and gas measurements.

These and other features of the present invention will become readily apparent upon further review of the following specification and drawings.

### BRIEF DESCRIPTION OF THE DRAWINGS

The sole FIGURE is a schematic diagram of a well gauging system according to the present invention.

Similar reference characters denote corresponding features consistently throughout the attached drawings.

### DETAILED DESCRIPTION OF THE PREFERRED EMBODIMENTS

As shown in the drawing, the well gauging system includes a first containment vessel 17 and a second containment vessel 15. A typical customer source CSC at a well site provides a valve regulated stream into the test system 10 and a valve regulated return stream back to the customer source CSC. A common inlet line to the vessels is comprised of a pressure safety valve 61, which shunts some of the source stream back to the return stream when the source stream input to the valve exceeds a predetermined value. The input stream is then routed through a manual isolation valve 59. Source stream regulation is achieved via 3 way bypass valve V-11 57, which can dump excessive source pressure back into the return stream.

The common inlet includes divert valves on each inlet line of the vessels. For example, vessel A 17 has inlet divert valve V-2A 43 while vessel B15 has inlet divert valve V-2B 39. The inlet line divert valves 39 and 43 may be opened or closed by a programmable logic controller (PLC), such as, for example a FieldVision® stand alone net oil Solution computer NOS, or the like.

A common outlet line leads from the vessels back to form a return stream. The common outlet line to the vessels 15 and 17 has divert valves on each outlet line. For example, vessel A 17 has outlet divert valve V-1A 45 while vessel B 15 has outlet divert valve V-1B 41. As in the case of the inlet line, the outlet divert valves 45 and 41 may also be opened or closed by a PLC, NOS, or the like.

A common gas line is attached to the top of each vessel. The common gas line has low and high pressure regulators formed by the D1 combination of valves 19, 21, 25, 27, and 29, to allow control of the vessels' internal pressure. A similar D1 combination of gas regulation valves 33, 35 and 37 is located near leak detection points P1 proximate to pressure regulator 31. To monitor system integrity, a plurality of leak detection probes P1 are disposed throughout the system 10. The D0 valve V-12 23 allows for cycling of the Nitrogen instrument or make-up gas to either vessel B 15 or vessel A 17. Gas pressure regulated via the aforementioned valves is measured at measurement points 38a and 38b. Further regulation of the vessel internal pressures is achieved by check valve 51 which feeds the return stream which in turn has check valve regulation performed by check valve 53. The manual isolation 55 is normally open and returns the stream to the customer production site CSC.

A vertical level indication level transmitter LT is disposed in the A tank 17. The B tank 15 also has a vertical level indication transmitter LT. The leveling indicator transmitters LT are utilized for controlling level in each vessel.

A water cut meter 47 reports water cut of the production stream. A Coriolis flow meter 49 is used for metering volume, density, temperature and reporting water cut at a range determined by the operating program of a NOS.

Under PLC or NOS control, production from a well or a test header, which has many wells attached, (labeled CSC in the diagram) diverts production stream through well test system 10 and totalizes the volume and water cut, which is used to calculate oil and water produced by the well over a 24 hour period. Under PLC (or NOS) control, the production stream cycles through the two vessels, vessel A 17 and vessel B 15 in an oscillatory manner. As the production stream fills vessel A 17 the heavier density fluids remain in vessel A 17, while the lighter density gas fills vessel B 15. After vessel A 17 has filled to a fixed set point the production stream is diverted to vessel B 15 and a dump valve V-1A 45 is opened on vessel A 17. As the production stream fills vessel B 15, the gas that was diverted to vessel B 15 is forced back to vessel A 17 thus forcing the production fluids that are in vessel A 17 through the metering equipment of system 10 which comprises Coriolis meter 49 and water cut probe 47 in the return line back to the production line at CSC. This process is repeated until the test time has been achieved or a net oil or gross volume has been reached. After completion of the well test the data is stored in the PLC or NOS and may be sent to a host computer via radio, satellite cell phone or cell phone.

The gas exit on the vessels is used to control the vessel pressures keeping them within our operating range. The gas exit line is comprised of a nitrogen cylinder, a low pressure regulator, a high pressure regulator and a pressure safety valve. If the pressure is lower than the set point of the low pressure regulator the gas cylinder adds pressure to the system and if the pressure is higher than the high set point the excess pressure is released back to the production line.

Preferably, the capacity of both tanks 15 and 17 is approximately 5.5 BBL. The system 10 may be mobile or fixed and can operate using solar power, site power, or generator power. Advantageously, the system 10 charges the first vessel 17 with oil and water, and the second vessel 15 with gas from the test well, and then reuses the gas to push production from the second vessel 15 with back up gas supply. The method of using two vessels allows more time for the emulsion to separate, thus increasing the accuracy of the oil, water, and gas measurements.

As shown in the drawing, a typical customer source CSC at a well site provides a valve regulated stream into the test system 10 and a valve regulated return stream back to the customer source CSC, and a three-way bypass valve 57.

It is to be understood that the present invention is not limited to the embodiment described above, but encompasses any and all embodiments within the scope of the following claims.

I claim:

1. A well gauging method, comprising the steps of:
inputting production stream from an oil well to a first vessel and a second vessel through a common inlet and respective first and second inlet divert valves;
outletting a return stream from the first and second vessels by a common outlet through respective first and second outlet divert valves;
verifying fluid levels in both the first vessel and the second vessel;
providing instrumentation gas to both the first vessel and the second vessel;
repetitively cycling instrumentation gas and production fluid alternately into the first vessel and the second vessel; and
measuring flow rate and water cut in the return stream.

2. The well gauging method according to claim 1, further comprising the step of shunting a portion of the source stream back to the return stream when the source stream input pressure exceeds a predetermined safe value.

3. The well gauging method according to claim 1, further comprising the step of selectively controlling each vessel's internal pressure.

4. The well gauging method according to claim 1, further comprising the step of totalizing the volume and water cut used to calculate oil and water produced by the well over a 24-hour period.

5. A well gauging system, comprising:
means for inputting production stream from an oil well to a first vessel and a second vessel through a common inlet and respective first and second inlet divert valves;
means for outletting a return stream from the first and second vessels by a common outlet through respective first and second outlet divert valves;
means for verifying fluid levels in both the first vessel and the second vessel;
means for providing instrumentation gas to both the first vessel and the second vessel;
means for repetitively cycling instrumentation gas and production fluid alternately into the first vessel and the second vessel; and
means for measuring flow rate and water cut in the return stream.

6. The well gauging system according to claim 5, further comprising means for shunting a portion of the source stream back to the return stream when the source stream input pressure exceeds a predetermined safe value.

7. The well gauging system according to claim 5, further comprising means for selectively controlling each vessel's internal pressure.

8. The well gauging system according to claim 5, further comprising means for totalizing the volume and water cut used to calculate oil and water produced by the well over a 24 hour period.

9. A well gauging system, comprising:
two containment vessels;
a common inlet line to the vessels;
divert valves branching from the common inlet line to each of the vessels, the divert valves being adjustable;
a programmable logic controller (PLC) alternately opening and closing the divert valves according to program instructions executable by the programmable logic controller, thereby cycling well production stream through the two vessels in an oscillatory manner, the PLC controlling well testing processes, storing results, and sending the results to a customer's central computer;
a common outlet line extending from the two vessels;
a common gas line attached to the top of each of the vessels;
low and high pressure regulators in operable communication with the vessels, the regulators providing for control of the vessels' internal pressures;
a vertical level indication device for controlling fluid level in each of the vessels;
a water cut meter connected to the PLC for reporting water cut of the production stream; and
a coriolis meter connected to the PLC.

10. The well gauging system according to claim 9, further comprising a pressure safety valve disposed in the common inlet line to the vessels, the pressure safety valve shunting a portion of the source stream back to the return stream when the source stream input pressure exceeds a predetermined safe value.

11. The well gauging system according to claim 9, further comprising low and high pressure regulators disposed in said common gas line, the low and high pressure regulators selectively controlling each of the vessels' internal pressure.

12. The well gauging system according to claim 9, wherein the PLC has electronic calculating circuitry totalizing the volume and water cut, the totalized volume and water cut being used to calculate oil and water produced by the well over a 24-hour period.
